(19) United States
(12) Patent Application Publication
(10) Pub. No.: US 2005/0042419 A1
(43) Pub. Date: Feb. 24, 2005

(54) Method for manufacturing plugged honeycomb structural body, mask for forming plugging part therefor, and method for manufacturing the mask

(75) Inventor: Shigeki Kato, Nagoya-city (JP)

Correspondence Address: OLIFF & BERRIDGE, PLC, P.O. BOX 19928, ALEXANDRIA, VA, 22320, US

(73) Assignee: NGK INSULATORS, LTD., Nagoya-city (JP)

(21) Appl. No.: 10/909,424

(22) Filed: Aug. 3, 2004

(30) Foreign Application Priority Data
Aug. 19, 2003 (JP) 2003-295519

(51) Int. Cl. B32B 3/10

(52) U.S. Cl. 428/131

(57) ABSTRACT

A method for manufacturing a plugged honeycomb structural body capable of producing inexpensively in a short period of time with reducing the amount of industrial waste is provided. The method comprises photographing at least one end face of a honeycomb structure body to acquire an image data to specify the shapes and locations of cells to be plugged and cells not to be plugged, preparing a mask for forming plugged portions having hole portions connectable with the cells to be plugged and projections engageable at least with one part of the honeycomb structure body based on the image data using a photofabrication method, and forming plugged portions by introducing a ceramic slurry into the cells to be plugged via the hole portions of the mask, while securing the mask to the end face of the structure body by using the projections to be engaged at least a part thereof.

### DESCRIPTION OF BACKGROUND ART

1. Field of the Invention

The present invention relates to a method for manufacturing a plugged honeycomb structural body having a large number of cells as passages for gases and plugged portions formed by alternately plugging the openings in a checkered pattern both at one end and the other end, suitably used as a filter for purifying exhaust gases discharged from combustion engines such as a diesel engine or various types of combustion equipment to collect particulates contained therein.

2. Prior Art

Exhaust gases discharged from combustion engines such as a diesel engine or various types of combustion equipment contain a large amount of particulate matters (fine particulate substances) including soot (black carbon smoke) as a major component. Since particulate matters cause environmental pollution if emitted into the atmosphere as they are, a filter for the collection of the particulate matters is mounted in the exhaust gas passages from combustion engines and the like.

As the filter used for such a purpose, a honeycomb filter 1 using a plugged honeycomb structural body 8 having a large number of cells 4 formed in a honeycomb-like form partitioned by porous partition walls 2 to be used as gas passages, and plugged portions 6 formed alternately by plugging the openings in a checkered pattern both at one end and the other end, as shown in FIG. 1, can be given. If exhaust gas G₁ is fed into the cells 4 from the exhaust-gas inlet side B of the honeycomb filter 1 shown in FIG. 1, purified gas G₂ can be obtained from the purified gas outlet side C since particulate matters in the exhaust gas G₁ are collected by the partition walls 2 when the gas G₁ passes through the partition walls 2.

As a method for manufacturing this type of plugged honeycomb structural body, the present inventors have proposed a method for obtaining a plugged honeycomb structural body comprising (i) providing a pressure sensitive adhesive sheet or the like with openings at portions corresponding to cells of a honeycomb structural body to be plugged (cell to be plugged), the openings having been produced by laser processing or the like utilizing image processing, (ii) attaching the pressure sensitive adhesive sheet or the like to one end face of a honeycomb formed article (a non-fired, but dry ceramic body) as a mask, (iii) immersing the end face of the honeycomb formed article with the mask attached thereto into a slurry (a ceramic slurry), filling the cells to be plugged of the honeycomb formed article with the slurry to form plugged portions, (iv) implementing the above steps (i) to (iii) on the other end face of the honeycomb formed article, and (v) drying and firing the honeycomb formed article (see JP-A-2001-300922).

Since the above-mentioned method can utilize a means such as image processing and laser beam machining, the method is advantageous in that (i) the openings can be easily produced only on the parts corresponding to the cell to be plugged even if the honeycomb formed article has a low configuration accuracy and (ii) the process can be comparatively easily automated. The method is therefore very useful.

However, to manufacture a large amount of plugged honeycomb structural bodies using the above-mentioned method, (i) it is necessary to implement the steps of attaching the pressure sensitive adhesive sheet, processing images, producing openings, and peeling-off the pressure sensitive adhesive sheet from both end faces of each honeycomb structural body after the plugging step, involving time-consuming work for preparation of mask and the like. Additionally, a large amount of peeled-off pressure sensitive adhesive sheets which must be disposed as industrial waste; and (ii) the pressure sensitive adhesive sheet is not only comparatively expensive, giving rise to an increase in the production cost, but also requires the clean environment free from dust to attach adhesive sheet to the extruded honeycomb body that imposes a limitation to the environment for the attaching process. That is, the above-mentioned method can be said to be effective for manufacturing a comparatively small number of plugged honeycomb structural bodies, but not necessarily satisfactory from the viewpoint of the adaptability for mass-production.

### SUMMARY OF THE INVENTION

The present invention has been completed in view of the problems in the prior art mentioned above. That is, the object of the invention is to provide a method that is suitable for mass production of a plugged honeycomb structural body and, more particularly, a method for manufacturing a plugged honeycomb structural body inexpensively in a short period of time irrespective of the environment for processing, with reducing the amount of industrial waste.

As a result of extensive studies to achieve the above objective, the present inventors have found that the above objective can be achieved by preparing a mask for forming plugged portions by a photo fabrication technique based on image data acquired from at least one end face of the honeycomb structural body. This finding has led to the completion of the present invention. Specifically, the present invention provides a method for manufacturing a plugged honeycomb structural body, a mask for forming plugged portions therefor, and a method for manufacturing the mask, as is mentioned below.

(1) A method for manufacturing a plugged honeycomb structure body, having a large number of cells formed in the shape of a honeycomb and being partitioned by porous partition walls to be used as gas passages, the cells being provided with plugged portions formed by alternately plugging the openings at one end and the other end, the method comprising steps of:
acquiring image data from at least one end face of the honeycomb structural body, by which the shapes and locations of cells to be plugged and cells not to be plugged can be specified,
obtaining a mask for forming plugged portions having hole portions connectable with cells to be plugged and projections engageable at least with one part of the honeycomb structure body based on the image date using a photofabrication method, which comprises the steps of providing a layer of non-cured photocurable composition, lithographically irradiating the surface of the layer with light to produce a cured resin layer, forming a new cured resin layer in the same manner on the upper surface of the cured resin layer, and repeating this lamination step until a mask having a predesigned shape is obtained, and
forming the plugged portions by introducing a ceramic slurry into the cells to be plugged via the holes of the mask for forming plugged portions, while securing the mask for forming plugged portions to the end face of the honeycomb structure body by causing the projections to engage at least a part of the honeycomb structural body.

(2) A method for manufacturing a mask for forming plugged portions used for forming plugged portions formed by alternately plugging openings at one end and the other end of a honeycomb structure body which has a large number of cells formed in the shape of a honeycomb partitioned by porous partition walls to be used as gas passages, the method comprising steps of:
acquiring image data from at least one end face of the honeycomb structural body, by which the shapes and locations of cells to be plugged and cells not to be plugged can be specified, and
obtaining a mask for forming plugged portions having hole portions connectable with cells to be plugged and projections engageable at least with one part of the honeycomb structure body based on the image date using a photofabrication method, which comprises the steps of providing a layer of non-cured photocurable composition, lithographically irradiating the surface of the layer with light to obtain a cured resin layer, forming a new cured resin layer in the same manner on the upper surface of the cured resin layer, and repeating this lamination step until the predesigned shape is formed.

(3) A mask for forming plugged portions usable for forming plugged portions by alternately plugging the chosen openings at one end and the other end of a honeycomb structure body which has a large number of cells formed in the shape of a honeycomb partitioned by porous partition walls to be used as gas passages, wherein the mask is formed from a photocurable resin composition and has hole portions to be connected with the cells to be plugged and projections engageable at least with one part of the honeycomb structure body.

(4) The mask for forming plugged portions according to (3) above, wherein the projections are securing pins engageable with cells not to be plugged of the honeycomb structure body in a number of three to a number corresponding to the number of the cells not to be plugged.

(5) The mask for forming plugged portions according to (4) above, wherein the projections are securing pins engageable with the cells not to be plugged in a number of three to a number corresponding to one half of the number of cells not to be plugged.

### BRIEF DESCRIPTION OF THE DRAWINGS

FIG. 1 is a schematic cross-sectional view of one embodiment of a conventional honeycomb filter.

FIG. 2 is a schematic sectional view showing an embodiment of the mask for forming plugged portions used in the manufacturing method of the present invention.

FIGS. 3(a), 3(b) and 3(c) are schematic sectional views showing embodiments of the mask for forming plugged portions used in the manufacturing method of the present invention.

FIG. 4 is a schematic side view showing an embodiment of the process for forming plugged portions used in the manufacturing method of the present invention.

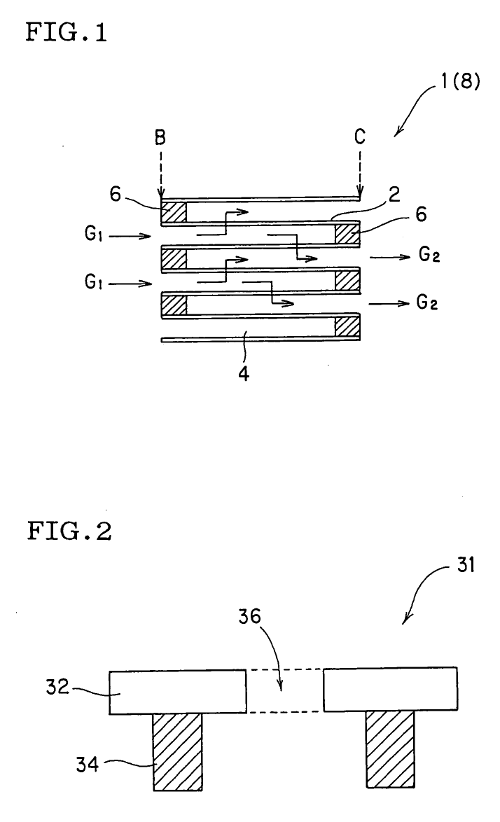

### DETAILED DESCRIPTION OF THE INVENTION AND PREFERRED EMBODIMENT

Using the method for manufacturing a plugged honeycomb structural body of the present invention plugged honeycomb structural bodies can be manufactured inexpensively in a short period of time irrespective of the environment for processing, while reducing the amount of industrial waste. The method is suitable for mass production.

Since the mask for forming plugged portions is prepared based on the image data of an actual honeycomb structural body, a mask with a high accuracy conforming to the configuration of the honeycomb structural body as extruded can be prepared even if there are some deviations due to deformation and the like during extrusion in the shape of the extruded honeycomb structural body, compared with the originally designed shape. Therefore, it is possible to form plugged portions at right positions exactly even in honeycomb structural bodies with a high cell density (a large number of cells).

Embodiments of the method for manufacturing a plugged honeycomb structural body of the present invention (hereinafter referred to simply as “manufacturing method of the present invention”) will be described below in detail. However, the present invention is not limited to these embodiments, as far as it is within the scope of the present claimed invention. In the present invention, the term “honeycomb structural body” refers to a honeycomb structural body before being plugged.

(1) First Step (End Face Image Acquisition Step)

The first step of the manufacturing method of the present invention is an end face image acquisition step comprising acquiring image data from at least one end face of a honeycomb structural body, so as to make it possible to specify the shapes and locations of cells to be plugged and cells not to be plugged.

Since a honeycomb structural body, that is, the honeycomb structural body before the formation of plugged portions, is usually manufactured by extruding a puddle or clay, the cell form, thickness of partition wall, cell density, and the like may vary lot by lot and the like, and some distortion may be observed in the honeycomb structural body obtained. However, if an image on at least one end face that can specify the shapes and locations of cells to be plugged and cells not to be plugged can be acquired as mentioned above, a mask for forming plugged portions conforming to the structure of the honeycomb structural body can be prepared.

More specifically, because the method can produce projections on the mask for forming plugged portions at exact positions in a proper shape, it is possible to cause such projections to engage the end face and cells not to be plugged of the honeycomb structure body with ease and to certainly secure the mask for forming plugged portions to the end face of the honeycomb structure body. In addition, since the holes for the mask for forming plugged portions also can be formed at right positions in a proper shape, it is possible to properly introduce ceramic slurry for forming the plugged portions into the cells to be plugged of the honeycomb structural body and to exactly form the plugged portions on the cell to be plugged.

It is not always necessary to acquire the image of the end face for each honeycomb structural body. As mentioned above, since the honeycomb structural body is usually manufactured by extrusion molding of a puddle or clay, the states of formed distortions in cell form, thickness of partition wall, and cell density may be the same if the composition of the puddle or clay is the same and the puddle or clay is kneaded and extruded under the same conditions. If one piece of image data is acquired for one honeycomb structural body, the mask for forming plugged portions prepared based on this image data can be used for all other honeycomb structure bodies formed from the production lots with the same conditions in these respects. That is, the mask for forming plugged portions can be reused. The manufacturing method of the present invention is therefore applicable to mass production.

The apparatus for acquiring the image of at least one end of the honeycomb structure body is not specifically limited. For example, a CCD (charge-coupled device) camera and an X-ray CT (computed tomography) scanner can be preferably used. Of these, the X-ray CT scanner is preferable for fabricating a mask for forming plugged portions excellently conforming to the structure of the honeycomb structural body, because the scanner can acquire images not only at the end face of a honeycomb structural body, but of the inside of the honeycomb structural body (internal configuration and the like of the cells). Moreover, the X-ray CT scanner has an advantage of easy preparation of cut plane figure data (slice data) of the mask for forming plugged portions required for photo fabrication, since the X-ray CT scanner can directly take a tomogram of the honeycomb structure body.

The honeycomb structural body used for the manufacturing method of the present invention has a large number of cells to function as gas passages partitioned by partition walls of a porous material in the form of a honeycomb.

There are no specific limitations to the quality of the material to be used for forming the honeycomb structure body (main body (outer walls), partition walls and the like) inasmuch as the above-mentioned conditions are satisfied. Since partition walls must be porous, a fired body made of ceramic (for example, cordierite) is suitably used. There are also no specific limitations to the shape of the honeycomb structure body. Various shapes such as a cylinder, quadratic prism, and triangular prism may be used. There are also no specific limitations to the shape of the cells (the cell shape in a plane vertical to the gas passage). Various shapes such as a quadrangle, hexagon, and triangle may be used.

There are no specific limitations to the manufacturing method of the honeycomb structure body. For example, a honeycomb structure body can be obtained by extruding a ceramic puddle or clay adjusted to a suitable viscosity using an extrusion mouthpiece having a desired cell form, thickness of partition wall, and cell density (cell pitch) and drying the extruded product.

(ii) Second Step (Step for Preparing a Mask for Forming Plugged Portions)

The second step of the manufacturing method of the present invention is a step for preparing a mask for forming plugged portions having holes connectable with cells to be plugged of the honeycomb structure body and projections engageable at least with one part of the honeycomb structure body based on the image data acquired in the first step using a photo fabrication method.

The photo fabrication method is a method for obtaining a three dimensional fabricated product formed from an optically cured resin composition. The method comprises providing a layer of a photocurable composition that is not cured yet, lithographically irradiating the surface of the layer with light to produce a cured resin layer, forming a new cured resin layer in the same manner on the upper surface of the cured resin layer, and repeating this lamination step until the predesigned shape is obtained. This method has an advantage in that three-dimensional bodies with a complicated shape that have been difficult to produce by a conventional molding method such as die molding and extrusion molding can be obtained quickly in a simple manner. Therefore, if the method of photo fabrication is applied to the manufacture of the above-mentioned mask for forming plugged portions, it is possible to obtain such a mask quickly and in a simple manner even if the mask has a complicated structure so as to cope with the deformations formed in the honeycomb structural bodies due to the factors such as, for example, the non-uniformity in the cell forms, the variation in thickness of partition walls within the honeycomb structural body, and the cell density. The modification of the shape of the mask is also easy.

The mask for forming plugged portions in this specification refers to a body formed from a photo cured resin having hole portions connectable with cells to be plugged of a honeycomb structure body and projections engageable with at least one part of the honeycomb structure body. There are no specific limitations to the overall shape of the mask for forming plugged portions inasmuch as the above conditions are satisfied. For example, a mask 31 for forming a plugged portions body shown in FIG. 2, having a hole part 36 and a projection part 34 formed on a mask main body 36 in the form of a plate with an area sufficient for covering the end face of the honeycomb structure body can be suitably used.

In addition, the holes are formed to have conductance with cells to be plugged of the honeycomb structure body. Ceramic slurry is introduced into the cells to be plugged through these holes to form the plugged portions in the cells to be plugged of the honeycomb structural body.

There are no specific limitations to the shape of the holes. The shape is not necessarily exactly the same as the shape of the cells to be plugged to the extent that the ceramic slurry can be introduced into the cell to be plugged of the honeycomb structural body. For example, the holes may be circular when the cell form of the honeycomb structure body is a quadrangle.

There are also no specific limitations to the size (area) of the holes inasmuch as the ceramic slurry can be introduced into the cell to be plugged of the honeycomb structural body. A specific size can be appropriately determined according to the viscosity of the ceramic slurry (i.e. taking into consideration ease of ceramic slurry introduction into the cells).

The projections have a shape engagebale with at least a part of the honeycomb structural body. The mask for forming plugged portions in the cells of the honeycomb structural body can be secured to the end face of the honeycomb structural body by causing the projections to engage at least a part of the honeycomb structural body.

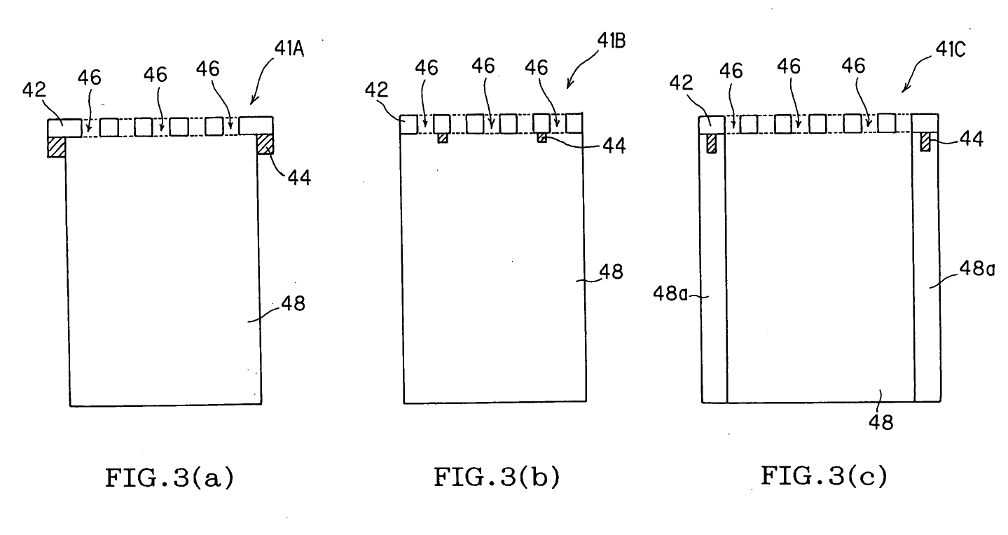

There are no specific limitations to the shape of the projections inasmuch as the projections can engage at least a part of the honeycomb structural body. For example, as shown in the mask 41A for forming plugged portions in FIG. 3(a), the projections may be in the form of a sheath projecting along the periphery of the honeycomb structure body 48 (a cap structure). In this case, the projections are not necessarily a continuous projection surrounding the entire circumference of the honeycomb structure body, but may be intermittent inasmuch as the mask for forming plugged portions can be secured to the end face of the honeycomb structure body. Note the numerical reference 46 in FIGS. 3(a) to (c) means the holes.

Alternatively, as shown in the mask for forming plugged portions 41B in FIG. 3(b), the shape of the projections 44 may be in the form of pins complementary to the cells not to be plugged of the honeycomb structure body 48. In this case, although there are no specific limitations to the number of securing pins forming the projections, at least one pin is necessary. However, since the cells to be plugged and the cells not to be plugged are alternately arranged in a checkered pattern, the maximum number of pins is equal to the cells not to be plugged (about ½ of the total cells).

To secure the mask for forming plugged portions to the end face of the honeycomb structure body, it is desirable to use at least three securing pins acting as the projections. On the other hand, the number of pins as projections is preferably equal to one half of the number of cells not to be plugged for easy mounting of the mask for forming plugged portions on the end face of the honeycomb structure body.

In the case of the honeycomb structure body manufactured via an extrusion article, a frequently adopted method is to remove the outer circumference including the external wall (a part in which no cells are present) and cells near the external wall by cutting and forming a new external wall by coating a ceramic slurry onto the outer periphery of the cut honeycomb structure body (for example, JP-A-4-64768 and JP-A-8-323727). Such a method is an effective method for removing deformed cells inevitably produced near the outer wall of the honeycomb structure body during extrusion molding and for obtaining a honeycomb structure body with sufficient strength.

When the method of removing the outer circumference of the honeycomb structure body is used, as shown in the mask for forming plugged portions 41C in FIG. 3(c), the shape of the projection 44 may be in the form of a pin complementary to the inserting holes previously formed on the outer periphery (working part 48a) removed by the cutting procedure (securing pin structure B). One effect obtained by the method of inserting securing pins in the outer periphery (working part 48a) is that damaged parts which may be produced during insertion of the securing pins can be removed by a cutting procedure thereafter.

In this case, although there are no specific limitations to the number of securing pins forming the projections, it is preferable to provide at least three pins for securely fixing the mask for forming plugged portions to the end f ace of the honeycomb structure body. In addition, the number of securing pins is preferably 10 or less to ensure easy mounting of the mask for forming plugged portions to the end face of the honeycomb structure body.

“Photocurable component” in the manufacturing method of the present invention means an oligomer, monomer, and the like having one or more functional groups that react by irradiation and form a crosslinking structure in the molecule. This type of the material is often called as a prepolymer. As a matter of course, the photocurable component includes a mixture of two or more prepolymers.

As examples of the oligomer, oligomers of a radically polymerizable photo-curable resin such as an unsaturated polyester resin, acrylic resin, and ene-thiol resin and a cationically polymerizable photo-curable resin such as an epoxy resin can be given. As examples of the monomer, radically polymerizable monomers such as an acrylic acid ester and methacrylic acid ester, and cationically polymerizable monomers such as an epoxy-containing compound can be given. “Photocurable component composition” in the manufacturing method of the present invention refers to a composition containing the photocurable component as a constituent.

The following methods can be given as the method for preparing a mask for forming plugged portions by a photo fabrication method based on the image data acquired in the first step.

First, a photograph of the end face of a honeycomb structural body is taken by a CCD camera to obtain surface image data. Next, the surface image data is binarized to specify the shapes and positions of cells to be plugged and cells not to be plugged. Then, three dimensional figure data for the mask for forming plugged portions that enables projections and holes to be formed in exact positions and to correct the shape with regard to the honeycomb structure body is prepared.

The image acquisition apparatus is not limited to a CCD camera. An X-ray CT scanner may also be used. Specifically, the three-dimensional figure data of the mask for forming plugged portions can also be obtained by taking a photograph of the honeycomb structure body (internal shapes and the like of cells in addition to the end face) by the X-ray CT scanner to acquire the tomography data containing the surface image and binarizing the tomography data, thereby specifying the shapes and positions of cell to be plugged and cells not to be plugged.

The term “binarizing” or “binarization” used in this specification refers to processing for classifying an image data into 256 gradations and converting the image into a monochrome binary image consisting of white areas with a brightness higher than a certain threshold value and black areas with a brightness lower than the threshold value. It is possible to identify partition wall areas (black) from cell areas (white) of a honeycomb structure body by binarization.

The above-mentioned three-dimensional figure data is transformed into CAD (computer-aided design) data, and cut plane figure data (slice data) consisting of data for a large number of layers of the mask for forming plugged portions can be prepared based on the CAD data. Cured resin layers of the cut plane figure can be formed by lithographically irradiating the surface of the uncured photocurable component composition according to the slice data. A new cured resin layer which continuously follows the previously formed cured resin layer can be formed by adding a one-layer amount of the uncured photocurable component composition onto the cured resin layer and lithographically irradiating the surface. The mask for forming plugged portions of optically cured resin composition can be obtained by repeating the lamination procedure a prescribed number of times. Since a plugged honeycomb structure body must have a large number of cells alternately plugged in a checkered pattern at one opening end face and the other opening end face, the mask for forming plugged portions is preferably prepared for each of the end faces.

As the light used for curing the photocurable components, light having a specific wavelength that can cure the photocurable components used, for example, ultraviolet light and visible light must be used. Ultraviolet light is particularly preferably used. Therefore, as the irradiation apparatus, a UV laser apparatus and the like which can be controlled by an NC (numerical control) control method can be suitably used. At the present, in addition to such an irradiation apparatus, a photofabrication apparatus equipped with a photocurable component feeder which supplies the photocurable components, a storage vessel which stores the photocurable components, and an elevator that can move each optically cure resin layer formed by irradiation up and down is commercially available (for example, SLA7000 manufactured by INCS Inc.). It is possible to produce the mask for forming plugged portions rapidly in a simple manner in the manufacturing method of the present invention by using this type of commercially available photofabrication apparatus.

(3) Third Step (Plugging Part Forming Step)

The third step of the manufacturing method of the present invention is a step for forming plugged portions by securing the mask for forming plugged portions prepared in the second step to the end face of the honeycomb structure body using the projections and introducing a ceramic slurry into the cells to be plugged via holes corresponding to the cells to be plugged of the mask for forming plugged portions.

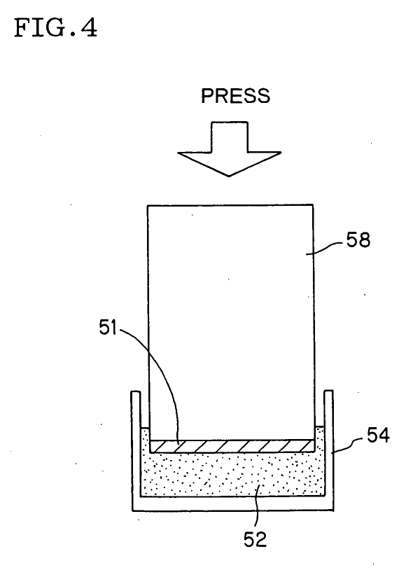

The third step can be carried out by the method shown in FIG. 4, for example. First, the mask for forming plugged portions 51 is secured to one of the end faces of the honeycomb structure body 58 using the projections. In this state, cells not to be plugged on that end face are masked. Then, the masked end face of the honeycomb structure body 58 is immersed in a storage vessel 54 containing the ceramic slurry 52 and pressed against the inner bottom of the storage vessel 54, whereby the ceramic slurry is introduced into the cells to be plugged of the honeycomb structure body 58 via the holes of the mask for forming plugged portions 51 and the plugged portions are formed.

After forming the plugged portions at the one end face of the honeycomb structure body 58 in this manner, the mask for forming plugged portions is removed and the same procedure is repeated for the other end face. A plugged honeycomb structure body having a large number of cells which are alternately provided with plugged portions in a checkered pattern at one opening end face and the other opening end face can be obtained by drying and firing the honeycomb structure body.

### EXAMPLES

The present invention will now be described in more detail by way of examples which should not be construed as limiting the present invention.

As the honeycomb structural body used in Examples and Comparative Examples, a honeycomb structure body was prepared from a porous material by forming a large number of cells to function as gas passages partitioned by partition walls in the form of a honeycomb. The honeycomb structure body was made from cordierite in the form of a cylinder with a length of 200 mm and a circular bottom with a diameter of 160 mm. The cells had quadrilateral sides, the partition wall thickness was about 300 μm, and the cell density was 300 per square inch.

The honeycomb structure body was prepared by extruding a puddle or clay adjusted to a suitable viscosity using an extrusion mouthpiece having the above-described cell form, thickness of partition wall, and cell density, drying the extruded product, and cutting both ends to make smooth end faces. In the following Examples and Comparative Examples, 100 plugged honeycomb structure bodies, each having a large number of cells which are alternately provided with plugged portions in a checkered pattern at one opening end face and the other opening end face, were prepared.

In the following Examples and Comparative Examples, a ceramic slurry for forming plugged portions was prepared from cordierite powder as a ceramic powder, methyl cellulose as a binder, and a high molecular weight surfactant as a deflocculant by mixing these components, adding water as a dispersant, and stirring the mixture for 30 minutes. The viscosity of the slurry was adjusted to 200 Pas.

### Comparative Example 1

After attaching a commercially available pressure sensitive adhesive sheet (made from polyester, thickness: 0.05 mm) onto one of the end faces of the honeycomb structure body, that one end face was photographed using a CCD camera to obtain surface image data. Next, the surface image data was binarized to specify the positions of cells to be plugged and cells not to be plugged. The main coordinate of the honeycomb structure body was calculated from the same surface image data. The mask for forming plugged portions was prepared by opening holes through the adhesive seat only at positions corresponding to the cell to be plugged by laser processing. As a result, only cells not to be plugged on that end face were masked.

Then, the masked end face of the honeycomb structure body was immersed in a storage vessel containing the ceramic slurry and pressed against the inner bottom of the storage vessel to cause the ceramic slurry to be introduced only into the cells to be plugged, thereby forming plugged portions. After repeating the same process on the other end face, the honeycomb structure body was dried and fired to obtain a plugged honeycomb structure body having a large number of cells which are alternately plugged in a checkered pattern at one opening end face and the other opening end face.

### Examples 1-3

A photograph of the end face of the above honeycomb structural body was taken to obtain surface image data. As the image acquisition apparatus, a CCD camera was used in Examples 1 and 2 and an X-ray CT scanner was used in Example 3. The surface image data was binarized to specify the shapes and positions of cell to be plugged and cells not to be plugged.

The main coordinate and the cell density (pitch between cells) of the honeycomb structure body were calculated from the same surface image data. Then, three-dimensional figure data for the mask for forming plugged portions that enables projections and holes to be formed in exact positions and for correcting the shape with regard to the honeycomb structure body was prepared. The above-mentioned three-dimensional figure date was transformed into CAD data, and slice data consisting of data for a large number of layers of the mask for forming plugged portions was prepared based on the CAD data.

Cured resin layers of the cut plane figure were formed by lithographically irradiating the surface of the uncured photocurable component composition according to the slice data. A new cured resin layer that continuously followed the previously formed cured resin layer was formed by adding a one-layer amount of the uncured photocurable component composition onto the cured resin layer and lithographically irradiating the surface. The mask for forming plugged portions of optically cured resin composition was obtained by repeating the lamination procedure a prescribed number of times.

UV light from a UV laser emitting apparatus was used for irradiation. A photofabrication apparatus SLA7000 (manufactured by INCS Inc.) was used. As the structure of the mask for forming plugged portions, the following mask A was used in Example 1 and the mask B was used in Examples 2 and 3.

(Mask A)

Mask A has a basic structure of the mask for forming plugged portions 31 shown in FIG. 2, comprising a mask main body 32 of a circular plate with an outer diameter of 160 mm and a thickness of 0.3 mm, provided with holes 36, each having a diameter of 1 mm, and projected portions (securing pins) 34 in the shape of a quadratic prism with a size of 1 mm×1 mm×1 mm (height). The holes 36 and projections 34 were arranged respectively to correspond to the cells to be plugged and cells not to be plugged and to form a checkered pattern as a whole. The numbers of the holes 36 and projections 34 were respectively about ½ of the total cells.

(Mask B)

Mask B has a basic structure of the mask for forming plugged portions 31 shown in FIG. 2, comprising a mask main body 32 of a circular plate with an outer diameter of 160 mm and a thickness of 0.3 mm, provided with holes 36, each having a diameter of 1 mm, and projected portions (securing pins) 34 in the shape of a quadratic prism with a size of 1 mm×1 mm×1 mm (height). The holes 36 were arranged to correspond to the cell to be plugged and to form a checkered pattern as a whole. The number of holes 36 was about ½ of the total cells. Three projections 34 (securing pins) were arranged to correspond to the cells not to be plugged in the central part of the end face of the honeycomb structure body.

As shown in FIG. 4, the mask for forming plugged portions 51 was secured to one of the end faces of the honeycomb structure body 58 using the projections. At this point, only cells not to be plugged on that end face were masked. Then, the masked end face of the honeycomb structure body 58 was immersed in a storage vessel 54 containing the ceramic slurry 52 and pressed against the inner bottom of the storage vessel 54 to cause the ceramic slurry to be introduced only into the cell to be plugged, thereby forming plugged portions, whereupon the mask for forming plugged portions 51 was removed. The same process was implemented at the other end face of the honeycomb structure body. A plugged honeycomb structure body having a large number of cells which are alternately plugged in checkered pattern at one opening end face and the other opening end face was obtained by drying and firing the resulting honeycomb structure body.

The time required for preparing the mask, including the time for acquiring the image and data processing time, the time required for mounting the mask (mask mountability: per one mask on one end face), processing time (per both end faces of 100 honeycomb structure bodies), the time required for opening holes (per one mask on one end face), production of industrial wastes, and performance of plugged portions were evaluated for Comparative Example 1 and Examples 1-3. The results are shown in Table 1.

TABLE 1

| | | | | Comparative |
|---|---|---|---|---|
| | Example 1 | Example 2 | Example 3 | Example 1 |
| Time required for preparing | (4 hours) | (4 hours) | (4 hours) | — |
| the mask | | | | |
| Time required for mounting | 30 seconds | 5 seconds | 5 seconds | — |
| the mask (per one mask on | | | | |
| one end face) | | | | |
| Time required for opening | — | — | — | 3 seconds |
| holes (per one mask on one | | | | |
| end face) | | | | |
| Processing time (per both | 100 minutes | 17 minutes | 17 minutes | 600 minutes |
| end faces of 100 honeycomb | | | | |
| structure bodies) | | | | |
| Production of industrial | None (Used | None (Used | None (Used | One sheet of |
| wastes | repeatedly) | repeatedly) | repeatedly) | adhesive tape |
| | | | | was disposed. |
| Performance of plugged | Good | Good | Good | Good |
| portions | | | | |

*No substantial processing time was required for preparing mask in Examples 1-3, since the mask was prepared simultaneously with the completion of the honeycomb structure bodies.

Evaluation

In the manufacturing method of Comparative Example 1, three minutes were required for opening holes in one end face of one adhesive sheet and 600 minutes were required for processing 100 honeycomb structure bodies. In contrast, in Example 1 in which the mask was prepared concurrently with the finish processing of the honeycomb structure bodies, the substantial mask preparation time was regarded as zero and the mask was smoothly mounted, requiring only 30 seconds for mounting per one end face. Consequently, the processing time for plugging both end faces of 100 honeycomb structure bodies was 100 minutes, showing a decrease as compared with the manufacturing method of Comparative Example 1. In the manufacturing method of Examples 2 and 3, in which three securing pins were used, the mask was mounted more easily and the time was greatly reduced, requiring only 17 minutes for plugging both end faces of 100 honeycomb structure bodies.

In case of the manufacturing method of Comparative Example 1, one should dispose one adhesive sheet per every one end face of a honeycomb structural body as an industrial waste. Thus, this method requires the cost for disposing the used adhesives. On the other hand, in case of the manufacturing method of Examples 1 to 3, the amount of industrial waste to be discharged was remarkably reduced, resulting in a significant reduction of the waste discharge cost.

The manufacturing method of the present invention can be suitably used for manufacturing a plugged honeycomb structural body having a large number of cells to be used as gas passages and plugged portions for alternately plugging the openings at one end and the other end, suitably used as a filter for purifying exhaust gases discharged from combustion engines such as a diesel engine or various types of combustion equipment by collecting particulates contained therein.

1. A method for manufacturing a plugged honeycomb structure body, having a large number of cells formed in the shape of a honeycomb partitioned by porous partition walls to be used as gas passages, the cells being provided with plugged portions alternately plugging the openings at one end and the other end, the method comprising steps of:
acquiring image data from at least one end face of the honeycomb structural body, by which the shapes and locations of cells to be plugged (cell to be plugged) and cells not to be plugged (cells not to be plugged) can be specified,
obtaining a mask for forming plugged portions having hole portions connectable with cell to be plugged and projections engageable at least with one part of the honeycomb structure body based on the image date using a photofabrication method, which comprises providing a layer of uncured photocurable composition, lithographically irradiating the surface of the layer with light to produce a cured resin layer, forming a new cured resin layer in the same manner on the upper surface of the cured resin layer, and repeating this lamination step, and
forming the plugged portions by introducing a ceramic slurry into the cell to be plugged via the holes of the mask for forming plugged portions, while securing the mask for forming plugged portions to the end face of the honeycomb structure body by causing the projections to engage at least a part of the honeycomb structural body.

2. A method for manufacturing a mask for forming plugged portions used for forming plugged portions alternately plugging openings at one end and the other end of a honeycomb structure body which has a large number of cells formed in the shape of a honeycomb partitioned by porous partition walls to be used as gas passages, the method comprising steps of:
acquiring image data from at least one end face of the honeycomb structural body, by which the shapes and locations of cells to be plugged and cells not to be plugged can be specified, and
obtaining a mask for forming plugged portions having hole portions connectable with cell to be plugged and projections engageable at least with one part of the honeycomb structure body based on the image date using a photofabrication method, which comprises providing a layer of uncured photocurable composition, lithographically irradiating the surface of the layer with light to produce a cured resin layer, forming a new cured resin layer in the same manner on the upper surface of the cured resin layer, and repeating this lamination step until a mask having a predesigned shape is obtained.

3. A mask for forming plugged portions used for forming plugged portions alternately plugging openings in checkered pattern at one end and the other end of a honeycomb structure body which has a large number of cells formed in the shape of a honeycomb partitioned by porous partition walls to be used as gas passages, wherein the mask is formed from a photocurable resin composition and has holes to be connected with the cells to be plugged and projections engageable at least with one part of the honeycomb structure body.

4. The mask for forming plugged portions according to claim 3, wherein the projections are securing pins engageable with cells not to be plugged of the honeycomb structure body in from three to a number corresponding to the number of the cells not to be plugged.

5. The mask for forming plugged portions according to claim 4, wherein the projections are securing pins engageable with the cells not to be plugged in from three to one half of the number corresponding to the number of cells not to be plugged.
